(19) United States
(12) Patent Application Publication
(10) Pub. No.: US 2026/0042363 A1
(43) Pub. Date: Feb. 12, 2026

(54) VEHICLE LOWER PART STRUCTURE

(71) Applicant: TOYOTA JIDOSHA KABUSHIKIKAISHA, Toyota-shi (JP)

(72) Inventor: Katsunori HIGASHIHARA, Toyota-shi (JP)

(73) Assignee: TOYOTA JIDOSHA KABUSHIKIKAISHA, Toyota-shi (JP)

(21) Appl. No.: 19/073,633

(22) Filed: Mar. 7, 2025

(30) Foreign Application Priority Data
Aug. 9, 2024 (JP) 2024-134017

(51) Int. Cl. B60L 50/60; B62D 21/03; H01M 50/24; H01M 50/249

(52) U.S. Cl. CPC B60L 50/66; B62D 21/03; H01M 50/24; H01M 50/249; H01M 2220/20

(57) ABSTRACT

The present disclosure relates to a vehicle lower part structure. The battery pack is disposed between the pair of side members. The seal strip is bridged between the side member and the battery pack. Further, the seal strip extends in an inclined manner along the vehicle front-rear direction in a vehicle side view.

### CROSS-REFERENCE TO RELATED APPLICATION

This application claims priority to Japanese Patent Application No. 2024-134017 filed on Aug. 9, 2024. The disclosure of the above-identified application, including the specification, drawings, and claims, is incorporated by reference herein in its entirety.

### BACKGROUND

### 1. Technical Field

The present specification discloses a vehicle lower part structure.

### 2. Description of Related Art

A battery electric vehicle (BEV) is equipped with a battery pack. For example, the battery pack is disposed under the floor of the vehicle cabin.

For example, in Japanese Unexamined Patent Application Publication No. 2019-14349 (JP 2019-14349 A), a rocker of a skeleton member is provided at both ends of a vehicle body. The gap between the rockers and the battery pack is closed by an elastic seal material.

In Japanese Unexamined Patent Application Publication No. 2017-193290 (JP 2017-193290 A), a case of a battery pack is provided with a seal material. The seal material is provided over the entire periphery of a peripheral portion of an upper surface of the case. Further, a drain portion is formed by chipping a part of the seal material.

In Japanese Unexamined Patent Application Publication No. 2023-51652 (JP 2023-51652 A), a battery pack is supported by a frame. Further, a cover member is disposed on the battery pack and a lower surface of the frame. An annular seal material is disposed between an upper surface of the cover member and the lower surface of the frame.

### SUMMARY

The present specification discloses a vehicle lower part structure capable of quickly discharging a liquid accumulated on a seal member.

A first aspect of the present specification discloses a vehicle lower part structure. The structure includes a pair of side members, a battery pack, and a seal strip. The side members extend in a vehicle front-rear direction. In addition, the side members are disposed at both ends of a vehicle cabin in a vehicle width direction. The battery pack is disposed between the side members. The seal strip extends between the side members and the battery pack. Further, the seal strip extends in an inclined manner along the vehicle front-rear direction in a vehicle side view.

According to the above configuration, a liquid on the seal strip is discharged obliquely downward along the inclined seal strip.

In the above configuration, the seal strip may be a downward slope that lowers as the seal strip extends rearward in the vehicle front-rear direction.

According to the above configuration, a liquid on the seal strip easily flows rearward in a vehicle that mainly travels forward.

In the above configuration, rear ends of the side members may be connected to a cross member. The cross member may extend in the vehicle width direction. The cross member may be a hollow member. Both ends of the cross member in the vehicle width direction may be opened. A rear end of the seal strip may abut against an inner wall of the cross member. A discharge hole may be provided in the inner wall of the cross member at a location of abutment with the rear end of the seal strip.

According to the above configuration, a liquid is discharged from the seal strip to the outside of the vehicle by way of the cross member.

In the above configuration, a rear seal strip may be installed in a gap between the cross member and a rear end of the battery pack. The rear seal strip may be installed so as to have a mountain shape. That is, a center portion of the rear seal strip in the vehicle width direction may serve as a peak, and the rear seal strip may lower toward outer sides in the vehicle width direction.

According to the above configuration, a liquid that has entered the gap between the cross member and the rear end of the battery pack can be caused to flow to both ends in the vehicle width direction.

In the above configuration, the seal strip may be U-shaped in cross section.

According to the above configuration, the seal strip can be used as a gutter.

According to the vehicle lower part structure disclosed in the present specification, it is possible to quickly discharge a liquid accumulated on a seal member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view illustrating a vehicle cabin structure;

FIG. 2 is a single perspective view of a battery case;

FIG. 3 is a single perspective view of the battery case in a direction opposite to that of FIG. 2;

FIG. 4 is a cross-sectional view of A-A of FIG. 1 illustrating a fastening configuration of a battery case;

FIG. 5 is a single perspective view of the frame;

FIG. 6 is a single perspective view of the frame in a front-back orientation as opposed to FIG. 5; and

FIG. 7 is a cross-sectional view showing a first alternative example (U-shaped seal) of FIG. 4.

### DETAILED DESCRIPTION OF EMBODIMENTS

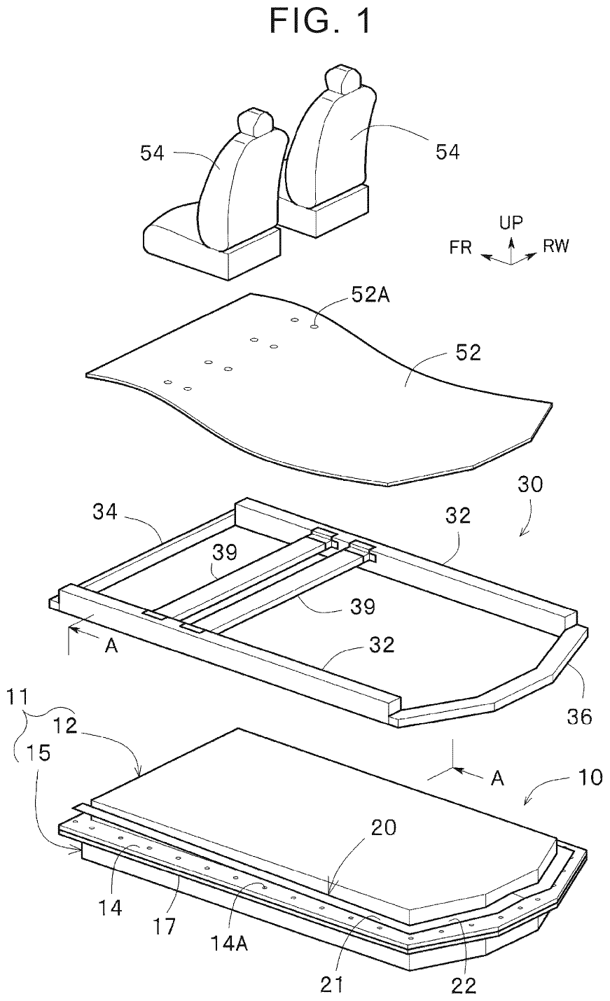

FIG. 1 to FIG. 7 illustrate a vehicle lower part structure according to the present embodiment. The vehicle lower part according to the present embodiment is mounted on a battery electric vehicle (BEV). The vehicle lower part structure according to the present embodiment includes a battery pack 10, a seal strip 20, and a frame 30.

In FIGS. 1 to 7, the front-rear direction of the vehicle is indicated by a FR shaft. The vehicle-width direction is indicated by RW shaft. The vertical is indicated by UP axis. FR shaft has a forward direction. RW shaft shall be rightward in the positive direction. The height direction of UP shaft is the positive direction.

### Vehicle Cabin Structure

FIG. 1 is an exploded perspective view of a vehicle component around a vehicle cabin. A battery pack 10 is disposed under the floor of the vehicle cabin. The battery pack 10 is supported by the frame 30. The frame 30 is a frame-shaped frame member. For example, the frame 30 supports the entire circumference of the battery pack 10.

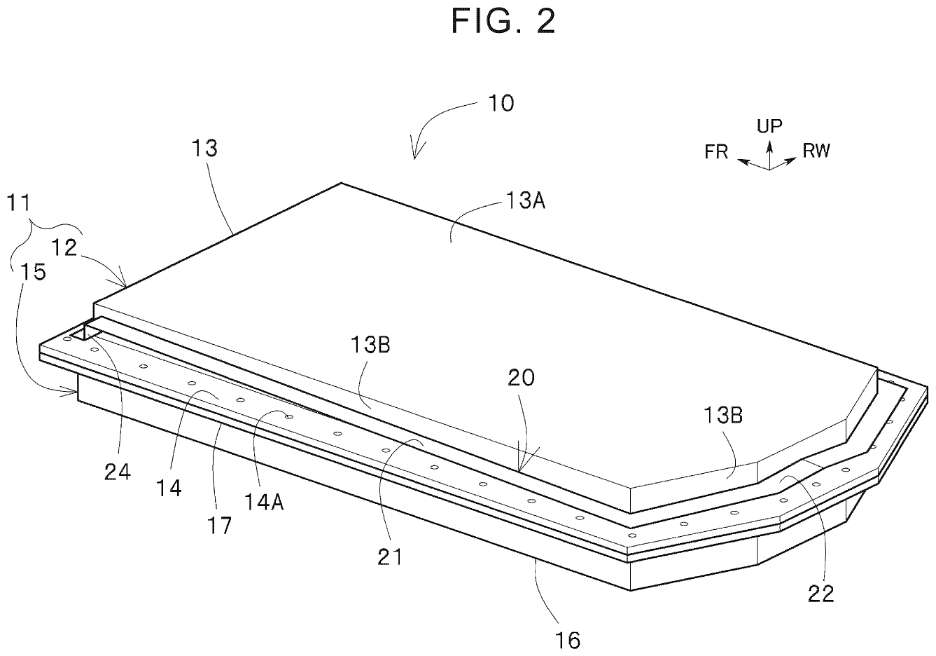

The battery pack 10 includes a battery case 11. The battery case 11 includes an upper case 12 and a lower case 15. The upper wall 13A (see FIG. 2) of the upper case 12 also functions as a floor panel of the vehicle cabin. That is, the floor carpet 52 is laid on the upper wall 13A.

A seat bracket 39 is fixed to the frame 30. The seat bracket 39 extends, for example, in the vehicle width direction. In addition, a pair of seat brackets 39 is provided, for example, side by side in the vehicle front-rear direction.

A floor carpet 52 is laid on the frame 30 and the battery pack 10. Further, the seat 54 is fastened to the seat bracket 39 via the fastening hole 52A of the floor carpet.

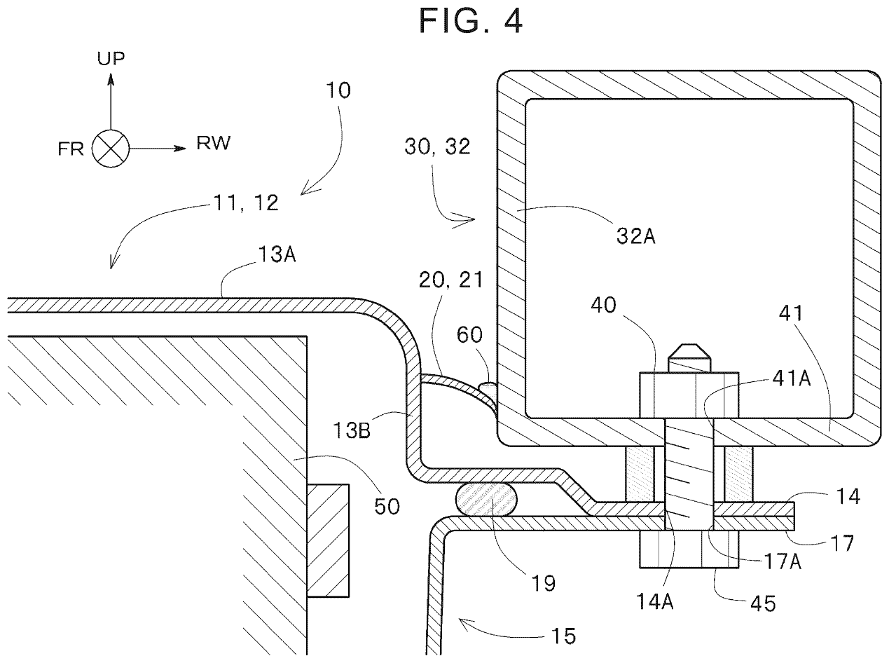

Further, the upper case 12 of the battery pack 10 is provided with a seal strip 20. Along the side wall 13B (see FIG. 2) of the upper case 12, the seal strip 20 is provided annularly. FIG. 4 illustrates a side member 32 that is a component of the frame 30. The seal strip 20 abuts the inner wall 32A of the side member 32. That is, the seal strip 20 is bridged between the side member 32 and the battery pack 10.

As shown in FIG. 4, the gap between the battery pack 10 and the frame 30 is sealed by the seal strip 20 over the entire circumference. Therefore, the seal strip 20 suppresses the vehicle exterior noise such as road noise from leaking from the gap between the battery pack 10 and the frame 30 into the vehicle cabin.

As described above, since the upper wall 13A of the battery pack 10 (see FIG. 2) also serves as a floor panel, the liquid spilled on the floor carpet 52 leaches out of the floor carpet 52 and reaches the battery pack 10. As further illustrated in FIG. 4, the liquid 60 flows into the seal strip 20 spanned between the battery pack 10 and the frame 30. As will be described later, the seal strip side 21 (see FIG. 2) is inclined along the vehicle front-rear direction in a vehicle side view. Accordingly, the liquid is discharged obliquely downward along the inclined seal strip 20.

### Frame

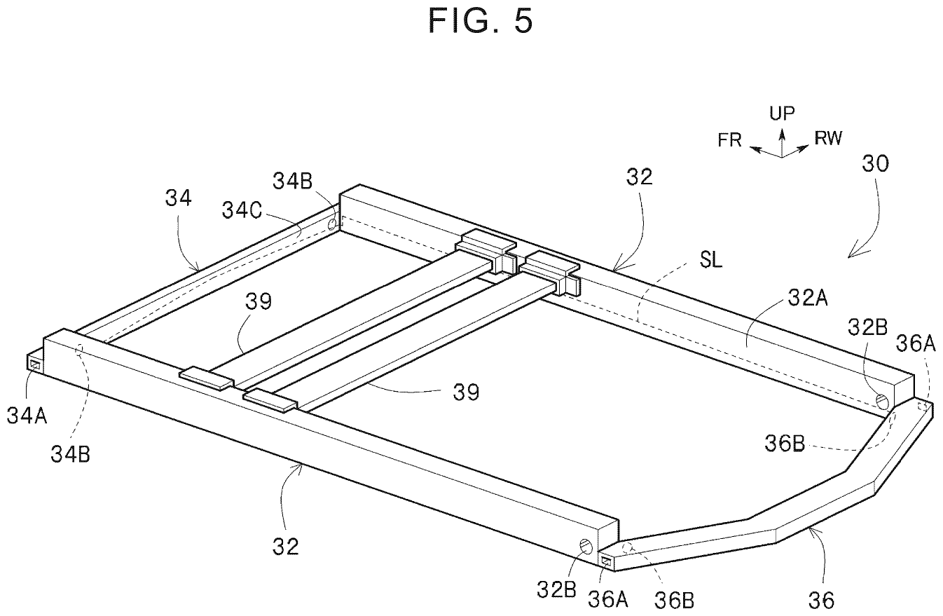

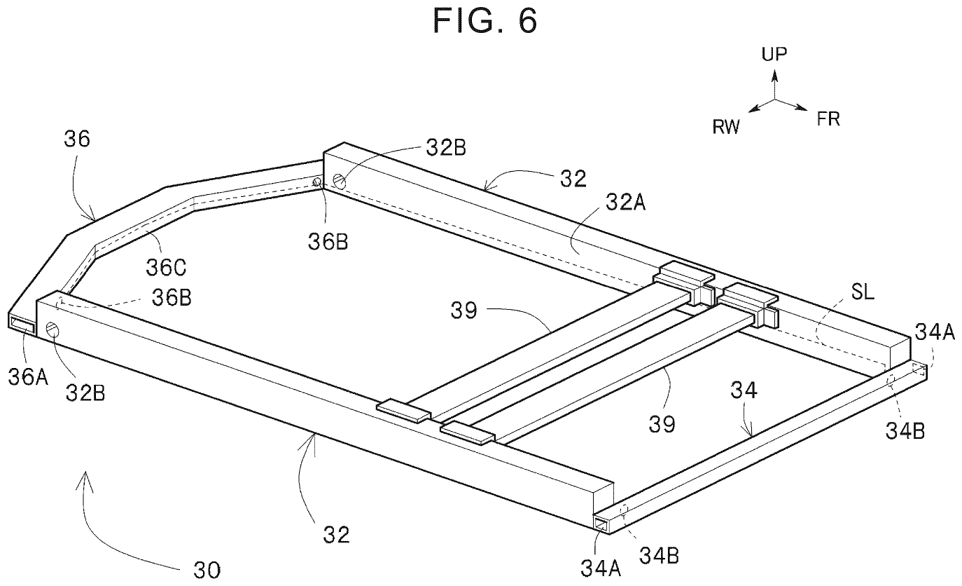

FIG. 5 illustrates a single perspective view of the frame 30. FIG. 6 illustrates a single perspective view of the frame 30 viewed from a direction opposite to that of FIG. 5. FIG. 4 is a cross-sectional A-A view of FIG. 1.

The frame 30 comprises, for example, a hollow structure. For example, the cross section of the frame 30 is rectangular. A fastening hole 41A is drilled in the bottom wall 41 of the frame 30. The fastening hole 41A penetrates the bottom wall 41 in the thickness direction.

A weld nut 40 is provided inside the frame 30. The weld nut 40 is coaxial with the fastening hole 41A. As will be described later, the fastening hole 14A, 17A of the battery pack 10 is aligned with the fastening hole 41A. Bolts 45 (fasteners) are screwed into these fastening holes 14A, 17A, 41A. Accordingly, the battery pack 10 is fastened to the frame 30.

Referring to FIGS. 5 and 6, the frame 30 is a frame-shaped skeletal component. The frame 30 includes a pair of side members 32 and 32, a front cross member 34, and a rear cross member 36.

The pair of side members 32 and 32 extend in the vehicle front-rear direction. The side members 32 and 32 are disposed at both ends of the vehicle cabin in the vehicle width direction. The battery pack 10 is disposed between the pair of side members 32 and 32. The side members 32 and 32 are hollow members. The side members 32 and 32 are formed of, for example, a square pipe. The front and rear ends of the side members 32 and 32 are closed by a metal plate or the like.

A discharge hole 32B is formed in each of the side members 32 and 32. The discharge hole 32B passes through, for example, the side members 32 and 32. The discharge hole 32B is provided, for example, at the rear end part of the side members 32 and 32. For example, a cylindrical inner wall may be attached to the discharge hole 32B. As described below, at least a portion of the discharge hole 32B is passed through the seal line SL by the seal strip 20.

The front ends of the side members 32 and 32 are connected to the front cross member 34. The pair of side members 32 and 32 are joined to the front cross member 34 by welding, for example. For example, the front cross member 34 has a smaller height dimension than the side members 32 and 32.

The front cross member 34 extends in the vehicle width direction. The front cross member 34 is a hollow member. The front cross member 34 is formed of, for example, a square pipe. As illustrated in the opening 34A of FIGS. 5 and 6, both vehicle-width-direction ends of the front cross member 34 are opened.

Further, a discharge hole 34B is formed on the inner wall 34C of the front cross member 34. The discharge hole 34B passes through the inner wall 34C in the front-rear direction of the vehicle. For example, the discharge hole 34B is provided at both vehicle-width-direction end portions of the front cross member 34. As described below, at least a portion of the discharge hole 34B is passed through the seal line SL by the seal strip 20.

The rear ends of the side members 32 and 32 are connected to the rear cross member 36. The pair of side members 32 and 32 are joined to the rear cross member 36 by welding, for example. For example, the rear cross member 36 has a smaller height dimension than the side members 32 and 32.

The rear cross member 36 extends in the vehicle width direction. Further, the vehicle width direction center portion of the rear cross member 36 protrudes toward the rear of the vehicle as compared with both end portions in the vehicle width direction. The rear cross member 36 is a hollow member. The rear cross member 36 is formed by bending a square pipe, for example. As illustrated in the opening 36A of FIGS. 5 and 6, both vehicle-width-direction ends of the rear cross member 36 are opened.

Further, a discharge hole 36B is formed on the inner wall 36C of the rear cross member 36. The discharge hole 36B passes through the inner wall 36C in the front-rear direction of the vehicle. For example, the discharge hole 36B is provided at both vehicle-width-direction end portions of the rear cross member 36. As described below, at least a portion of the discharge hole 36B is passed through the seal line SL by the seal strip 20.

As will be described later, the rear end of the seal strip side 21 (see FIG. 2) abuts against the inner wall 36C of the rear cross member 36. In the inner wall 36C, a discharge hole 36B is formed at the abutting portion. That is, the discharge hole 36B is disposed at the end of the seal strip side 21 disposed in the downward inclined shape.

### Battery Pack

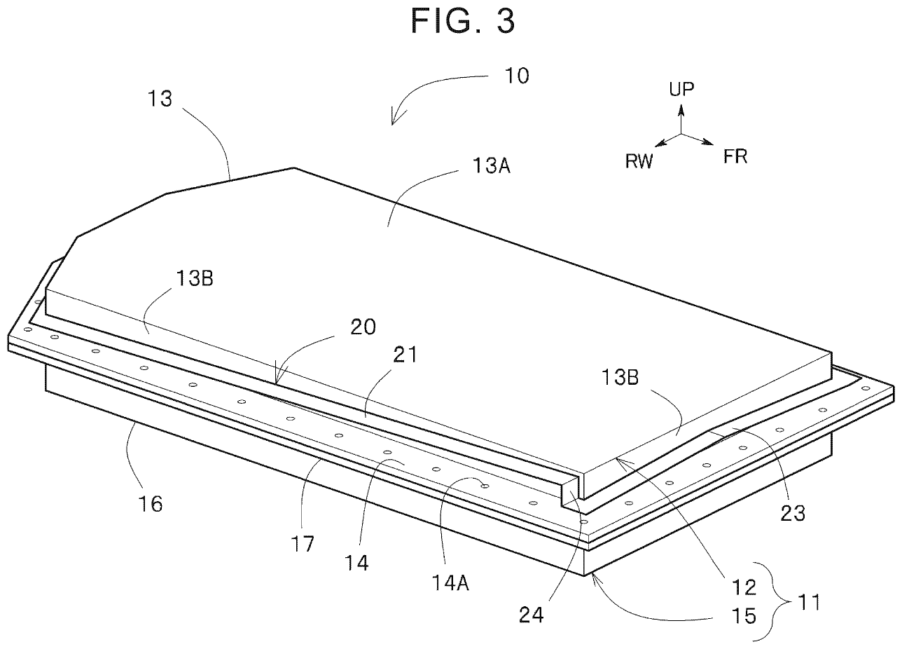

Referring to FIGS. 2 and 3, the battery pack 10 is a box-shaped large component. For example, the battery pack 10 is disposed on the floor of the vehicle cabin. The battery pack 10 supplies electric power to a rotary electric machine (not shown) which is a driving source of the vehicle.

The battery pack 10 is supported by the frame 30. Referring to FIGS. 1 and 4, a plurality of fastening hole 14A, 17A are drilled in the upper flange 14 and the lower flange 17 of the battery pack 10, for example. The upper flange 14 and the lower flange 17 are formed over the entire circumference of the battery pack 10. The fastening hole 14A, 17A is formed over the entire circumference of the upper flange 14 and the lower flange 17. Therefore, the battery pack 10 is fastened and supported to the frame 30 over the entire circumference.

Referring to FIG. 4, the battery pack 10 includes a battery case 11 and a plurality of battery cells 50. The battery case 11 houses the battery cells 50. The battery cell 50 includes, for example, a nickel-hydrogen secondary battery, a lithium-ion secondary battery, and an all-solid-state battery.

Referring to FIGS. 2 and 3, the battery case 11 includes an upper case 12 and a lower case 15. The lower case 15 includes a tray portion 16 and a lower flange 17. The lower case 15 is made of a metal panel such as an aluminum panel. For example, the lower case 15 is formed by press working. A plurality of battery cells 50 are arranged in the tray portion 16.

The lower flange 17 is disposed at the periphery of the tray portion 16. For example, the lower flange 17 surrounds the tray portion 16 over the entire circumference. The lower flange 17 is provided at an upper end portion of the tray portion 16.

The upper case 12 is a lid portion of the battery case 11. For example, the upper case 12 is formed of a metal panel such as an aluminum panel. For example, the upper case 12 is formed by press working.

The upper case 12 includes a cover portion 13 and an upper flange 14. The cover portion 13 is placed on the tray portion 16 of the lower case 15. The cover portion 13 includes an upper wall 13A and a side wall 13B. The upper wall 13A extends horizontally. The peripheral edge of the upper wall 13A is surrounded by the side wall 13B over the entire circumference. Referring to FIG. 4, the side wall 13B is erected with respect to the upper wall 13A.

An upper flange 14 is disposed on a peripheral edge of the cover portion 13. For example, an upper flange 14 is provided at a lower end of the cover portion 13. The upper flange 14 is provided over the entire circumference of the cover portion 13.

Referring to FIG. 4, a sealing material 19 is adhered between the upper flange 14 and the lower flange 17. The sealing material 19 is adhered over the entire circumference of the upper flange 14 and the lower flange 17. Accordingly, the battery cells 50 are enclosed in the battery case 11.

The upper wall 13A of the upper case 12 also serves as a floor panel of the vehicle cabin. Therefore, a reinforcing component (not shown) may be fixed to the inner surface of the upper wall 13A. The inner surface of the upper wall 13A refers to a surface facing the battery cell 50.

Further, the seal strip 20 is installed over the entire circumference of the side wall 13B. The seal strip 20 seals the gap between the battery pack 10 and the frame 30 (see FIGS. 5 and 6).

### Seal Strip

Referring to FIGS. 2 and 3, the seal strip 20 is a frame-shaped member. The seal strip 20 is made of an elastic material such as rubber. The seal strip 20 is bridged between the frame 30 and the battery pack 10.

The seal strip 20 comprises a pair of seal strip sides 21, 21, a seal strip front 23, a rear seal strip 22, and a connecting portion 24. The pair of seal strip sides 21 and 21 extends in the vehicle front-rear direction. The seal strip sides 21, 21 extend parallel to the side members 32 of the frame 30 (see FIG. 5).

The seal strip front 23 extends in the vehicle width direction. The seal strip front 23 extends parallel to the front cross member 34 of the frame 30. That is, the seal strip front 23 is disposed in a gap between the front cross member 34 and the front end of the battery pack 10.

The rear seal strip 22 extends in the vehicle width direction. The rear seal strip 22 extends along the rear cross member 36 of the frame 30. That is, the rear seal strip 22 is disposed in a gap between the rear cross member 36 and the rear end of the battery pack 10.

The seal strip sides 21 and 21 are inclined along the vehicle front-rear direction in a vehicle side view. For example, the seal strip sides 21 and 21 are inclined downward, which decreases toward the rear in the vehicle front-rear direction. The downward inclination makes it easy for the liquid on the seal strip sides 21 and 21 to flow backward in the vehicle in which the forward movement is the main operation. The seal strip sides 21 and 21 extend linearly from the front end to the rear end of the upper case 12.

Referring to FIG. 3, the seal strip front 23 is installed on the side wall 13B so as to be mountain-shaped. That is, the seal strip front 23 becomes lower toward the outside in the vehicle width direction with the center portion in the vehicle width direction as the apex.

Both ends of the seal strip front 23 in the vehicle width direction are lowest in the member. On the other hand, the front ends of the seal strip sides 21 and 21 are the highest in the member. To fill this height difference, a connecting portion 24 is provided. That is, both ends of the seal strip front 23 in the vehicle width direction are connected to the lower end of the connecting portion 24. A front end of the seal strip side 21 is connected to an upper end of the connecting portion 24. By providing the connecting portion 24, the seal strip 20 can be seamlessly surrounded by the side wall 13B.

Referring to FIG. 2, the rear seal strip 22 is installed on the side wall 13B so as to be mountain-shaped. That is, the rear seal strip 22 becomes lower toward the outside in the vehicle width direction with the center portion in the vehicle width direction as the apex. The liquid dropped onto the rear seal strip 22 flows down from the center in the vehicle width direction toward the end in the vehicle width direction. Both ends of the rear seal strip 22 in the vehicle width direction and the rear ends of the seal strip sides 21 and 21 are connected to each other.

As illustrated in FIG. 4, the tips of the seal strips 20 abut the inner wall 32A of the frame 30. The abutment of the seal strip 20 is shown by the seal-line SL in FIGS. 5 and 6. As shown in the seal line SL, the tips of the seal strips 20 seamlessly abut the inner wall 32A of the side members 32, 32, the inner wall 34C of the front cross member 34, and the inner wall 36C of the rear cross member 36. As a result, leakage of external noise into the vehicle cabin is suppressed.

Referring to FIGS. 2, 3, 5, and 6, the rear end of the seal strip side 21 abuts against the inner wall 36C of the rear cross member 36. A discharge hole 34B is drilled in a portion of the inner wall 36C which abuts against the rear end of the seal strip side 21. That is, the discharge hole 34B is connected to the downstream end of the seal strip side 21. Therefore, the liquid flowing down the seal strip side 21 enters the rear cross member 36 from the discharge hole 34B. Further, the liquid is discharged from the opening 36A of the rear cross member 36 to the outside of the vehicle.

Further, a discharge hole 32B is provided at a rear end portion of the side member 32. A part of the discharge hole 32B is passed through the seal strip side 21. Therefore, the liquid flowing down the seal strip side 21 is also discharged to the outside of the vehicle from the discharge hole 32B.

In addition, both vehicle-width-direction ends of the rear seal strip 22 abut on the inner wall 32A of the side member 32. A discharge hole 32B is drilled in an abutting portion of the inner wall 32A with both vehicle-width-direction ends of the rear seal strip 22. Therefore, the liquid flowing down the rear seal strip 22 is discharged from the discharge hole 32B to the outside of the vehicle. In addition, the liquid flowing down the rear seal strip 22 is also discharged to the outside of the vehicle through the discharge hole 36B.

Referring to FIGS. 3 and 5, a discharge hole 34B is drilled in both vehicle-width-direction end portions of the front cross member 34. As shown in the seal line SL, a portion of the discharge hole 34B is passed through the seal strip front 23. Accordingly, the fluid flowing down the seal strip front 23 flows from the discharge hole 34B into the front cross member 34. Further, the liquid flowing into the front cross member 34 is discharged from the opening 34A to the outside of the vehicle.

As described above, in the vehicle lower part structure according to the present embodiment, the seal strip 20 extends non-horizontally. Accordingly, the liquid dripped on the seal strip 20 moves along the slope of the seal strip 20.

Instead of connecting the discharge hole 36B to the downstream end of the seal strip 20, a water absorbing material such as a sponge may be provided. For example, the water absorbing material is disposed in the vicinity of the heat source in the vehicle. For example, in a heat exchange system, a pipe through which the high-temperature refrigerant compressed by the compressor flows is provided at the rear of the vehicle. A water absorbing material is disposed in the vicinity of the refrigerant pipe.

### Seal Strip 1st Example (U-Seal)

In the embodiment of FIG. 4, the tip of the seal strip 20 hangs from the root. Thus, the inner wall 32A of the frame contacts the liquid 60.

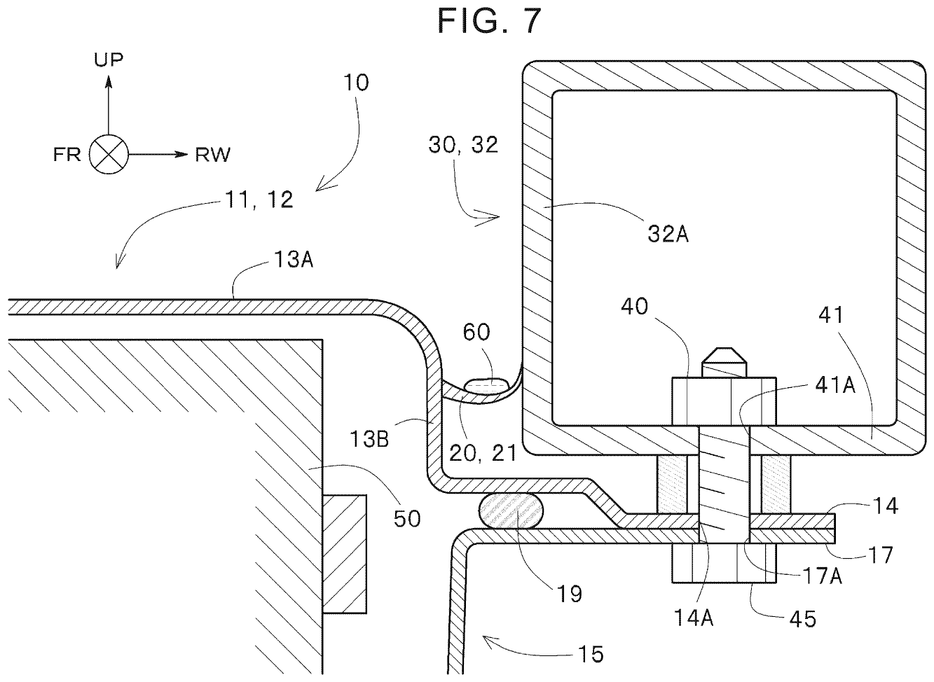

Instead of this configuration, as illustrated in FIG. 7, a seal strip 20 having a U-shaped cross section may be disposed between the battery pack 10 and the frame 30. According to this configuration, the seal strip 20 can be used as a trough. That is, contact between the battery pack 10 and the frame 30 and the liquid 60 is suppressed.

In the above-described embodiment, the seal strip 20 is attached to the battery pack 10. However, in the vehicle lower part structure according to the present embodiment, it is sufficient that the seal strip 20 is bridged between the frame 30 and the battery pack 10. Therefore, instead of the above-described embodiment, the seal strip 20 may be attached to the inner wall 32A, 34C, 36C of the frame 30.

What is claimed is:

1. A vehicle lower part structure comprising:
a pair of side members extending in a vehicle front-rear direction and disposed at both ends of a vehicle cabin in a vehicle width direction;
a battery pack disposed between the side members; and
a seal strip that extends between the side members and the battery pack, wherein the seal strip extends in an inclined manner along the vehicle front-rear direction in a vehicle side view.

2. The vehicle lower part structure according to claim 1, wherein the seal strip is a downward slope that lowers as the seal strip extends rearward in the vehicle front-rear direction.

3. The vehicle lower part structure according to claim 2, wherein:
rear ends of the side members are connected to a cross member that extends in the vehicle width direction;
the cross member is a hollow member, both ends of the cross member in the vehicle width direction being opened;
a rear end of the seal strip abuts against an inner wall of the cross member; and
a discharge hole is provided in the inner wall of the cross member at a location of abutment with the rear end of the seal strip.

4. The vehicle lower part structure according to claim 3, wherein:
a rear seal strip is installed in a gap between the cross member and a rear end of the battery pack; and
the rear seal strip is installed so as to have a mountain shape with a center portion in the vehicle width direction serving as a peak and lowering toward outer sides in the vehicle width direction.

5. The vehicle lower part structure according to claim 1, wherein the seal strip is U-shaped in cross section.
